(19) United States
(12) Patent Application Publication
(10) Pub. No.: US 2025/0029037 A1
(43) Pub. Date: Jan. 23, 2025

(54) DATA-DRIVEN DATA MANAGEMENT SYSTEM AND DATA MANAGEMENT METHOD

(71) Applicants: Digiwin Software Co., Ltd, Shanghai (CN); DATA SYSTEMS CONSULTING CO., LTD., New Taipei City (TW)

(72) Inventors: Qun Luo, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/461,522

(22) Filed: Sep. 6, 2023

(30) Foreign Application Priority Data
Jul. 17, 2023 (CN) 202310877656.0

(51) Int. Cl. G06Q 10/0631

(52) U.S. Cl. CPC G06Q 10/06316

(57) ABSTRACT

A data-driven data management system and data management method are provided. The data-driven data management system includes a storage device and a processor. The storage device is configured to store multiple process models. The processor is coupled to the storage device and configured to receive a setting data set. The processor performs a second compilation on the multiple assembly data sets to combine the multiple assembly data sets into multiple process data sets. The data-driven data management system and data management method of the disclosure are adapted to automatically perform two compilations on the setting data set according to the multiple process models, and then combine assembly data corresponding to the setting data set into the multiple process data sets.

### CROSS-REFERENCE TO RELATED APPLICATION

This application claims the priority benefit of China application serial no. 202310877656.0, filed on Jul. 17, 2023. The entirety of the above-mentioned patent application is hereby incorporated by reference herein and made a part of this specification.

### BACKGROUND

### Technical Field

The disclosure relates to a processing technology for encapsulating data, and particularly relates to a data-driven data management system and data management method.

### Description of Related Art

Conventional task processes are based on human judgment of tasks at each stage, and corresponding operations and adjustments are carried out based on personal experiences, so that each execution step requires manpower to perform data management and task process management based on the past experiences. Therefore, the conventional task process and data processing highly rely on human experiences and require manpower to make judgments item by item, which leads to a problem of not achieving a good experience reuse effect.

### SUMMARY

The disclosure is directed to a data-driven data management system and data management method, which are adapted to automatically generate corresponding assembly data sets according to a setting data set, and then combine the assembly data sets into multiple process data sets.

According to an embodiment of the disclosure, the data-driven data management system of the disclosure includes a storage device and a processor. The storage device is configured to store multiple process models. The processor is coupled to the storage device and configured to receive a setting data set. The processor performs a first compilation on the setting data set to generate multiple assembly data sets. The processor performs a second compilation on the multiple assembly data sets to combine the multiple assembly data sets into multiple process data sets.

According to an embodiment of the disclosure, the data management method of the disclosure includes following steps: receiving a setting data set by a processor; performing a first compilation on the setting data set by the processor to generate multiple assembly data sets; and performing a second compilation on the multiple assembly data sets to combine the multiple assembly data sets into multiple process data sets.

Based on the above description, the data-driven data management system and data management method of the disclosure are adapted to automatically generate assembly data sets related to task processes according to the setting data set input by a user for matching to corresponding process data sets.

To make the aforementioned more comprehensible, several embodiments accompanied with drawings are described in detail as follows.

### BRIEF DESCRIPTION OF THE DRAWINGS

FIG. 1 is a schematic circuit diagram of a data-driven data management system according to an embodiment of the disclosure.

FIG. 2 is a flowchart of a data management method according to an embodiment of the disclosure.

FIG. 3 is a schematic diagram of a data management system according to an embodiment of the disclosure.

FIG. 4 is a schematic diagram of a first compilation and a second compilation of an embodiment of the disclosure.

FIG. 5 is a schematic diagram of a data management system according to an exemplary embodiment of the disclosure.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

Firstly, the data-driven data management system and data management method of the disclosure may simplify difficulty and complexity of design of a business process flow and improve reusability. The process data sets described in various embodiments of the disclosure may be, for example, from inquiry instructions to generating material information in manufacturing, setting of a billing process in finance or a leave process, etc. These process settings and processing logics may be abstractly defined as the process data sets, and include contents of processing logics, processing data types, data states, features, etc. Moreover, for different types of raw data, there will be a series of corresponding processing logics in different states, so that the disclosure may encapsulate these process data sets into tasks. When encapsulating process data, it only need to select an involved process type (such as driving capability, restriction capability, assignment capability, decision capability, and control capability) and input basic settings (such as a trigger condition, a time parameter, a regular setting, a corresponding action, information content, an authority personnel, etc.), the data-driven data management system of the disclosure may automatically encapsulate it into an appropriate processing logic (i.e. a task logic), and combine it with the original processing logics (i.e. process data sets). In this way, the convenience of encapsulating the business processing flow may be greatly simplified and the reusability may be improved, and the appropriate task logic may be dynamically driven according to the change of the data at runtime for processing (i.e., data-driven).

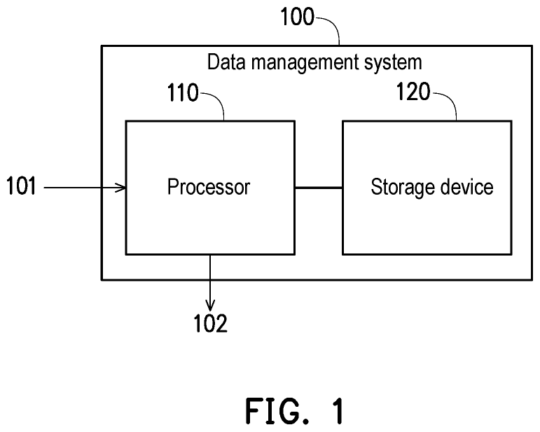

FIG. 1 is a schematic circuit diagram of a data-driven data management system according to an embodiment of the disclosure. Referring to FIG. 1, a data-driven data management system 100 includes a processor 110 and a storage device 120. The processor 110 is coupled to the storage device 120. The data-driven data management system 100 may also include an input device, a user interface, a communication interface, or a data transmission interface, etc., with actual circuit elements, so that the processor 110 may receive an instruction or signal of a process creation request, a process editing request, or a process encapsulate request from a data source or an external device or according to a user operation. In the embodiment, the data-driven data management system 100 may be, for example, a personal computer, a workstation computer, or other electronic devices with data computing capabilities. In an embodiment, the data-driven data management system 100 may also be integrated in a cloud server or a private server inside an enterprise. In an embodiment, the data-driven data management system 100 may be used, for example, to implement an enterprise resource planning (ERP) system, and may execute multiple application programming interfaces (API) to call multiple demand data (such as personnel data stored on other servers and material information stored on other servers, etc.). In an embodiment, a process data set 102 refers to a task logic (or program) used to execute a specific business function according to business data, for example, a task logic that may be used to execute a function of generating purchase orders according to purchase data, or a task logic that may be used to execute a function of generating purchase requisitions according to purchase requisition data, but the disclosure is not limited thereto.

In the embodiment, the processor 110 of the business data processing system 100 may include, for example, a central processing unit (CPU), or other programmable general purpose or special purpose microprocessor, digital signal processor (DSP), application specific integrated circuits (ASIC), programmable logic device (PLD), other similar processing circuits or a combination of these devices.

In the embodiment, the storage device 120 may implement a remote cloud storage service or a local data storage service. The storage device 120 may include a memory and/or a database), where the memory may be, for example, a non-volatile memory (NVM). The storage device 120 may store related programs, modules, systems or algorithms for implementing various embodiments of the disclosure, which may be accessed and executed by the processor 110 to realize the relevant functions and operations described in the various embodiments of the disclosure. The storage device 120 may also be used, for example, to cache structured and encapsulated process data described in various embodiments of the disclosure.

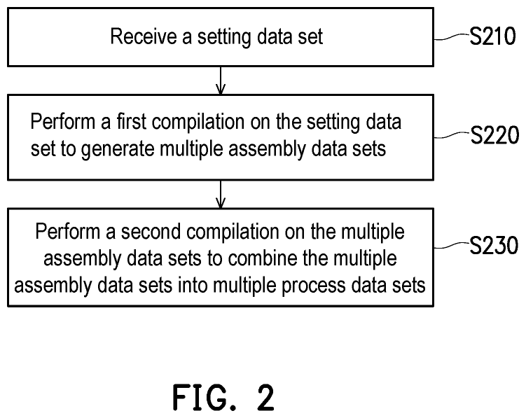

FIG. 2 is a flowchart of a data management method according to an embodiment of the disclosure. Referring to FIG. 1 and FIG. 2, the data-driven data management system 100 may execute the following steps S210-S230. In step S210, the processor 110 may receive a setting data set 101. In the embodiment, the processor 110 of the data-driven data management system 100 may receive the setting data set 101 from a data source. In this regard, the data source may be, for example, data acquired through an application program port or a process setting data input by a user. Alternatively, setting values included in the setting data set 101 may be data, environmental information, or artificial settings, etc., generated by certain sensors and specific data processing.

In step S220, the processor 110 performs first compilation on the setting data set 101 to generate multiple assembly data sets. In an embodiment, the assembly data set is a technical assembly. In the embodiment, the setting the data set refers to mapping certain transactions, processes, and processing logics in the real world into a digital domain for encapsulating into data. In the embodiment, the setting data set may include executing a corresponding process and operation according to a data state, executing a specific process (such as dispatching and filling a work order) and a field in raw process data (the field is described and implemented by language of a corresponding coding program) at a specific time according to a setting value.

For example, the assembly data set may be a target data flow, a data processing rule, a verification data setting assembly, or a behavior setting assembly. More specifically, the assembly data set may include multiple process components. The process component may be a data update component for updating data or re-fetching data, or a data browsing component for displaying and editing data, or a timing detection component for timing detection of data.

In step S230, the processor 110 performs a second compilation on the multiple assembly data sets to combine the multiple assembly data sets into multiple process data sets 102. In the embodiment, the process data set refers to an algorithm or logic that may process structured and encapsulated data, and a task logic in the process data set may define a range of data that may be processed. Regarding the second compilation, specifically, the processor 110 combines the assembly data set with the corresponding process data (which may be a process with the same target data, such as a task process for calculating a total number of employees). In other words, the processor 110 adjusts and updates the original task process (i.e., multiple process data sets) according to the assembly data set. Specifically, the processor 110 combines the new process data into the original process data set according to the target data and processing logics in a task assembly, a calculation component, and a Js component loop component in the setting data set, and then generates the updated process data set 102.

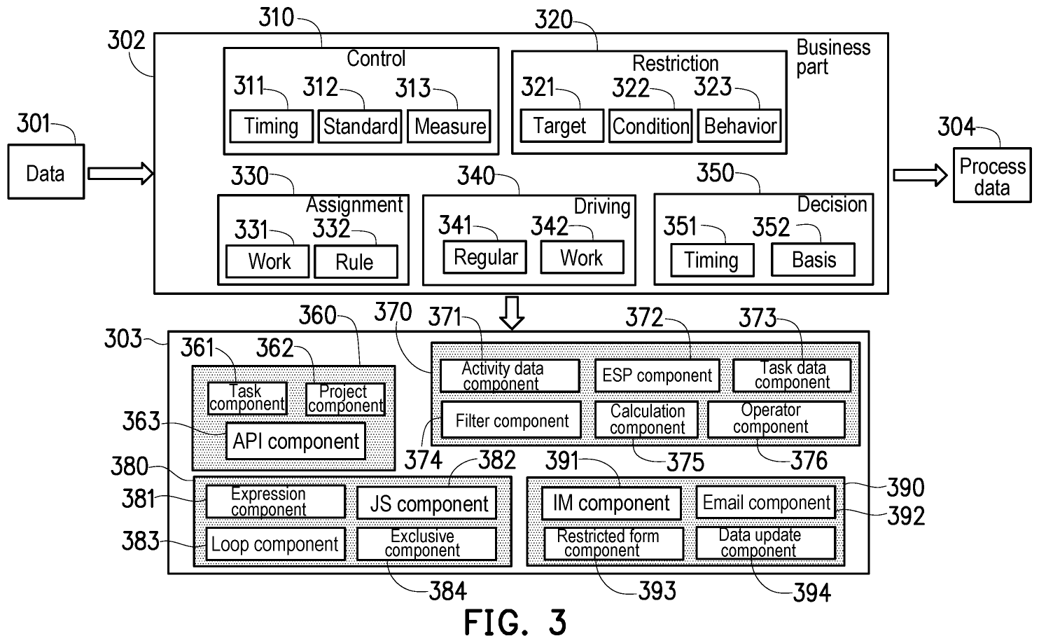

FIG. 3 is a schematic diagram of a data management system according to an embodiment of the disclosure. Referring to FIG. 1 and FIG. 3, the above step S210 further includes: the processor 110 displays multiple process models 302 on a display, and then receives multiple setting instructions input by the user. The multiple process models 302 includes a driving model 340, an assignment model 330, a control model 310, a decision model 350, and a restriction model 320. Each setting instruction is one of a selection instruction, a parameter setting instruction, a script input instruction, and an assignment instruction. Specifically, the data management system 100 further guides a user to input process settings and processing logics corresponding to different execution functions according to the multiple preset process models 302.

To be specific, the driving model 340 triggers the processor 110 to perform a corresponding process (such as dispatching work orders, displaying reminder information, and updating data) when detected data or parameter meets a specific condition (such as a specific time or specific data content). The restriction model 320 is to ensure that a business logic execution process must comply with the rules, i.e., a rule setting before a process operation. The decision model 350 is multiple options in the process logic (i.e., a business processing logic), which allows the processor 110 to select according to a preset value and perform subsequent processing through the preset value. For example, the preset value is to perform calculations, and the preset value may also be used to recommend options according to the rules, so as to simplify a decision-making process of the user and shorten the decision-making time required by the user. The control model 310 compares an execution result with a set standard value, and then confirms and verifies whether the execution result conforms to a default value (i.e., the set standard value). In the control model 310, when the execution result does not conform to the default value, the process logic is to the execute the related and corresponding subsequent process processing.

The assignment model 330 is a setting value of assigning a task to a specific personnel (for example, with a work experience is greater than 3 years, personnel who has dealt with the same task, and personnel with supervisory ranks) when there is a definite job or task that needs to be executed.

Furthermore, the driving model 340 includes a regular parameter 341 and a work parameter 342. In an embodiment, the regular parameter 341 is a frequency parameter, a time period, etc. The work parameter 342 is a specific task (for example, a task A) in a task process. For example, an on-site resource planning project (i.e., the regular parameter 341) needs to send an updated task card (i.e., the work parameter 342) to a production manager every day.

The assignment model 330 includes a work parameter 331 and a rule parameter 332. In an embodiment, the work parameter 331 is a specific task (such as the task A) in the task process. The rule parameter 332 is a specific personnel or a specific condition. For example, in an approval task (i.e., the work parameter 331), a reimbursement form with an approval amount greater than 10,000 yuan (the rule parameter 332) will be automatically assigned to a senior supervisor for approval, and the reimbursement form with an amount less than 10,000 yuan will be signed by an immediate supervisor.

The control model 310 includes a timing parameter 311, a standard setting parameter 312 and a measure parameter 313. In an embodiment, the timing parameter 311 is a setting parameter after a specific task is completed or a regular check parameter. The standard setting parameter 312 is a completion on time parameter a completion on quantity parameter. The measure parameter 313 is an alert notification or exception removal.

Regarding the control model 310, for example, before production of goods or process orders in the workshop goes online (i.e. the timing parameter 311), it is determined whether key materials of a critical path are ready (complete) (the standard setting parameter 312). When the key materials are not complete, an email reminder (that is, the measure parameter 313) is sent to a relevant staff. In this way, the setting of the control model 310 may automatically check the materials required for each process in advance, so as to avoid the fact that the work cannot be started due to that the materials are not complete when the manufacturing process is started, thereby improving the automation of the task process.

The decision model 350 includes a timing parameter 351 and a basis parameter 352. In an embodiment, the timing parameter 351 is a setting parameter when a specific task is started, and the basis parameter 352 is to perform evaluation according to an algorithm or an experience rule. For example, a new supplier is selected for materials that are often out of stock (i.e. the timing parameter 351), and the supplier that best meets the current task (for example, an available quantity and an available time all meet requirements of the current task) is calculated based on parameters such as a required supply time, an on-time supply rate, and an available quantity (i.e. the basis parameter 352).

The restriction model 320 includes a target parameter 321, a condition parameter 322 and a behavior parameter 323. For example, the target parameter 321 is during task execution or before task execution, the condition parameter 322 is based on personnel conditions or business rules, and the behavior parameter 323 is to display a prompt page or restrict form execution. When an employee needs to report abnormal working hours (i.e., the target parameter 321), a corresponding report time (i.e., the behavior parameter 323) is provided according to a position of the employee (i.e., the condition parameter 322). When the position of the employee is a general employee, only working hour content (i.e., the behavior parameter 323) of a current month may be reported. When the position of the employee is a senior officer, the working hour content (i.e., the behavior parameter 323) of the previous month and the current month may be reported. Based on such setting, the restriction model 320 may achieve task restriction and arrangement under different conditions, so as to improve stability and automation of the task process and data management.

In the embodiment, the storage device 120 stores association relationships between the multiple process models 302 and multiple assembly data sets 303. The above step S220 also includes that the processor 110 analyzes the setting data set 101 (i.e., data 301) and the multiple process models 302 to obtain the corresponding assembly data sets 303. The assembly data set 303 includes a target assembly 360, an activity assembly 370, a verification assembly 380 and a behavior assembly 390. In this way, the processor 110 performs the first compilation according to the corresponding model (i.e., the process model 302) and parameter data in the setting data set 101, and then respectively generates the target assembly 360, the activity assembly 370, the verification assembly 380 and the behavior assembly 390. Specifically, the target assembly 360 includes a task component 361, a project component 362, and an API component 363. The activity assembly 370 includes an activity data component 371, an ESP (encapsulating security payloads) component 372, a task data component 373, a filter component 374, a calculation component 375 and an operator component 376. The verification assembly 380 includes an expression component 381, a Js (JavaScript) component 382, a loop component 383 and an exclusive component 384. The behavior assembly 390 includes an IM (instant messaging) component 391, an email component 392, a restricted form component 393 and a data update component 394. The processor 110 analyzes component types corresponding to each assembly data set 303 from the setting data set 101 according to an input parameter or a setting instruction in the setting data set 101. For example, the processor 110 analyzes the timing parameter 311 from the setting data set 101, and classifies the timing parameter 311 into the task component 361 of the target assembly 360. The processor 110 analyzes the email reminder in the measure parameter 313, and then correspondingly generates the email component 392 in the behavior assembly 390. Namely, the processor 110 converts the setting data set 101 into the assembly data set 303 by performing the first compilation, and then generates the process data 304 to be combined.

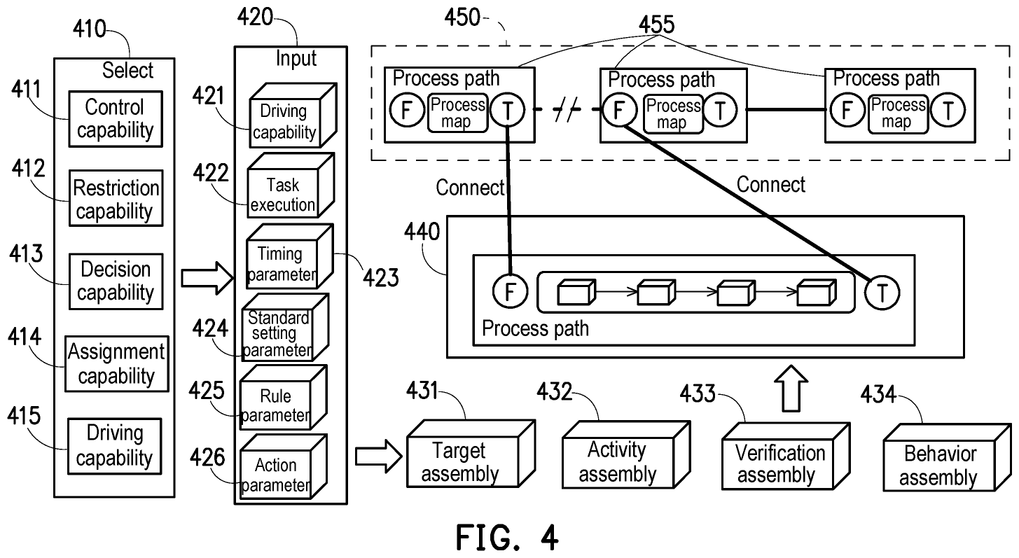

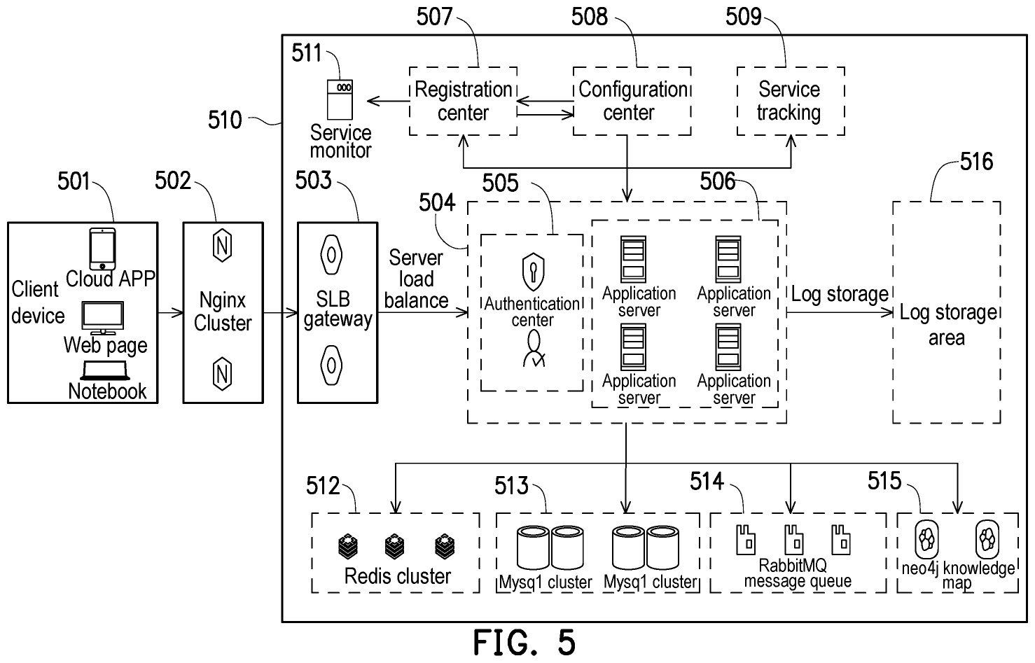

FIG. 4 is a schematic diagram of a first compilation and a second compilation of an embodiment of the disclosure. FIG. 5 is a schematic diagram of a data management system according to an exemplary embodiment of the disclosure. A data management system 510 also includes an application programming interface (API). The data management system 510 displays the multiple process models 410 on a display of a client device 501 through the API. In the embodiment, the API receives multiple setting instructions corresponding to the multiple process models to generate the setting data set 101, and outputs the setting data set to the processor. To be specific, the processor 110 selects one of a control capability 411, a restriction capability (i.e. the restriction model 320) 412, a decision capability (i.e. the decision model 350) 413, an assignment capability (i.e. the assignment model 330) 414 and a driving capability (i.e. the driving model 340) 415 through the user, and inputs various parameters 420 through the user, such as at least one of a regular parameter 421, task execution 422, a timing parameter 423, a standard setting parameter 424, a rule parameter 425 and an action parameter 426, and then receives the setting data set 101. In other words, the setting data set is input data input by the user, and the setting data set includes types of the process models 302 and the input parameters.

In an embodiment, a target assembly 431 is related to a target instance in the setting data set. An activity assembly 432 is related to a data acquisition path and a data processing setting in the setting data set. A verification assembly 433 is related to a comparison setting between standard data and data. A behavior assembly 434 is related to a setting of a state and a corresponding processing behavior. In an embodiment, the processor obtains data from one of the storage device and the server according to the activity assembly 432, and performs data processing on the data, and a data processing logic includes an execution logic and a calculation model. The processor of the data management system determines correctness of the data and the operation result according to the verification assembly 433. The processor performs a corresponding processing operation on the operation results according to the behavior assembly 434.

For example, the target assembly 431 includes a task target. The activity assembly 432 includes a data source path and a data processing logic. The verification assembly 433 includes a verification rule. The behavior assembly 434 includes a task execution setting. It should be noted that the processor may obtain corresponding process data from multiple process data according to the target assembly 431, i.e., obtain a task (i.e., process data) corresponding to the setting data set. In an embodiment, when the processor executes multiple process data, the processor obtains data according to the data source paths of the active assemblies 432 of multiple assembly data sets, and then performs verification operations and processing on the data. For example, a process data set 450 includes multiple process paths (i.e. process data) 455, and each process data corresponds to a different task stage, for example, to calculate data B from data A may be a first task stage, and then data B is operated with data C of another server to obtain data D, which may be a second task stage. Therefore, the processor may use the target assembly to match the task stage (that is, the process data) that meets the current target assembly from multiple process data.

In an embodiment, multiple process data sets form a data map or a process map. The above step S230 includes that the processor 110 searches the data map according to objects (i.e., the object assemblies 431) in the multiple assembly data sets, so as to obtain a corresponding process path (i.e., the process path 440). In this way, the processor 110 combines multiple assembly data sets to the process path 440 to update/create multiple process data sets 450.

In an embodiment, the data management system 510 also includes a service monitor 511, a server 502, a data management center 504, an authentication center 505, an application server 506, a registration center 507, a configuration center 508, and service tracking 509, but the disclosure is not limited thereto. The storage device may include a cache data storage area 512, a persistent data storage area 513, a message queue area 514, a knowledge map 515 and a log storage area 516. The server 502 may be an Nginx™ server, and the server 502 is configured to receive the setting data set from a terminal device (i.e., the client device 501) through the API, and input the setting data set to a server load balancer (SLB) 503. The server load balancer 503 inputs the setting data set to the multiple application servers 506 according to a current traffic. The registration center 507 is configured to store addresses of external servers. The configuration center 508 is configured to store a database and an address of the application server 506. The service tracking 509 is configured to record the calls and links of the server 502. Moreover, the registration center 507, the configuration center 508, and the service tracking 509 are configured to provide an interactive function (for example, to obtain a position of a current user from a member management server) between the data management system 510 and the external servers, and a log after the interaction may be stored in the log storage area 516. The authentication center 505 is configured to obtain the position and authority of the current user according to login information of the user.

Therefore, the data-driven data management system and data management method of the disclosure may convert the setting data set into the assembly data set through the first compilation, and then combine the assembly data set to multiple process paths according to the second compilation to obtain the updated process data. In this way, the data management system may be used for data management and data process encapsulation, so as to realize reuse of experience knowledge, encapsulation of processing logics and automatic data processing.

It will be apparent to those skilled in the art that various modifications and variations can be made to the disclosed embodiments without departing from the scope or spirit of the disclosure. In view of the foregoing, it is intended that the disclosure covers modifications and variations provided they fall within the scope of the following claims and their equivalents.

What is claimed is:

1. A data-driven data management system, comprising:
a storage device, configured to store a plurality of process models; and
a processor, coupled to the storage device,
wherein the processor receives a setting data set,
wherein the processor performs a first compilation on the setting data set to generate a plurality of assembly data sets,
wherein the processor performs a second compilation on the plurality of assembly data sets to combine the plurality of assembly data sets into a plurality of process data sets.

2. The data-driven data management system according to claim 1, further comprising an application program interface,
wherein the application program interface displays the plurality of process models on a display,
wherein the application program interface receives a plurality of setting instructions corresponding to the plurality of process models to generate the setting data set, and outputs the setting data set to the processor.

3. The data-driven data management system according to claim 1, wherein the plurality of process data sets form a data map,
wherein the processor searches the data map according to targets in the plurality of assembly data sets to obtain a process path,
wherein the processor combines the plurality of assembly data sets into the process path to update the plurality of process data sets.

4. The data-driven data management system according to claim 2, wherein the plurality of process models comprise a driving model, an assignment model, a control model, a decision model, and a restriction model, wherein each of the plurality of setting instructions is one of a selection instruction, a parameter setting instruction, a script input instruction, and an assignment instruction.

5. The data-driven data management system according to claim 4, further comprising a server, wherein the server receives the setting data set from a terminal device through the application program interface, and inputs the setting data set to a server load balancer,
wherein the server load balancer outputs the setting data set to a plurality of application servers according to a current traffic.

6. The data-driven data management system according to claim 4, wherein the driving model comprises a regular parameter and a work parameter, the assignment model comprises a work parameter and a rule parameter, the control model comprises a timing parameter, a standard setting parameter, and a measure parameter, the decision model comprises a timing parameter and a basis parameter, the restriction model comprises a target parameter, a condition parameter, and a behavior parameter,
wherein the processor performs the first compilation according to a corresponding model and parameter data in the setting data set, so as to respectively generate a target assembly, an activity assembly, a verification assembly, and a behavior assembly.

7. The data-driven data management system according to claim 1, wherein the processor analyzes the setting data set and the plurality of process models to obtain the plurality of assembly data sets, wherein the plurality of assembly data sets comprise a target assembly, an activity assembly, a verification assembly, and a behavior assembly.

8. The data-driven data management system according to claim 7, wherein the target assembly is related to a target instance in the setting data set, wherein the activity assembly is related to a data acquisition path and a data processing setting in the setting data set, wherein the verification assembly is related to a comparison setting between standard data and data, wherein the behavior assembly is related to a setting of a state and a corresponding processing behavior.

9. The data-driven data management system according to claim 7, wherein the target assembly comprises a task target, wherein the activity assembly comprises a data source path and a data processing logic, wherein the verification assembly comprises a verification rule, wherein the behavior assembly comprises a task execution setting.

10. The data-driven data management system according to claim 9, wherein the data processing logic comprises an execution logic and a calculation model.

11. A data management method, comprising:
receiving a setting data set by a processor;
performing a first compilation on the setting data set by the processor to generate a plurality of assembly data sets; and
performing a second compilation on the plurality of assembly data sets to combine the plurality of assembly data sets into a plurality of process data sets.

12. The data management method according to claim 11, wherein the step of receiving the setting data set by the processor comprises:
displaying a plurality of process models on a display by an application program interface,
receiving a plurality of setting instructions corresponding to the plurality of process models by the application program interface to generate the setting data set, and outputting the setting data set to the processor.

13. The data management method according to claim 11, wherein the plurality of process data sets form a data map, and the step of performing the second compilation on the plurality of assembly data sets to combine the plurality of assembly data sets into the plurality of process data sets comprises:
searching the data map by the processor according to targets in the plurality of assembly data sets to obtain a process path; and
combining the plurality of assembly data sets into the process path by the processor to update the plurality of process data sets.

14. The data management method according to claim 12, wherein the plurality of process models comprise a driving model, an assignment model, a control model, a decision model, and a restriction model, wherein each of the plurality of setting instructions is one of a selection instruction, a parameter setting instruction, a script input instruction, and an assignment instruction.

15. The data management method according to claim 14, wherein the step of receiving the setting data set by the processor comprises:
receiving the setting data set from a terminal device by a server through the application program interface, and inputting the setting data set to a server load balancer; and
outputting the setting data set to a plurality of application servers by the server load balancer according to a current traffic.

16. The data management method according to claim 14, wherein the driving model comprises a regular parameter and a work parameter, the assignment model comprises a work parameter and a rule parameter, the control model comprises a timing parameter, a standard setting parameter, and a measure parameter, the decision model comprises a timing parameter and a basis parameter, the restriction model comprises a target parameter, a condition parameter, and a behavior parameter,
wherein the step of performing the first compilation on the setting data set by the processor to generate the plurality of assembly data sets comprises:
performing the first compilation by the processor according to a corresponding model and parameter data in the setting data set, so as to respectively generate a target assembly, an activity assembly, a verification assembly, and a behavior assembly.

17. The data management method according to claim 11, wherein the step of performing the first compilation on the setting data set by the processor to generate the plurality of assembly data sets comprises:
analyzing the setting data set and a plurality of process models by the processor to obtain the plurality of assembly data sets, wherein the plurality of assembly data sets comprise a target assembly, an activity assembly, a verification assembly, and a behavior assembly.

18. The data management method according to claim 17, wherein the target assembly is related to a target instance in the setting data set, wherein the activity assembly is related to a data acquisition path and a data processing setting in the setting data set, wherein the verification assembly is related to a comparison setting between standard data and data, wherein the behavior assembly is related to a setting of a state and a corresponding processing behavior.

19. The data management method according to claim 17, wherein the target assembly comprises a task target, wherein the activity assembly comprises a data source path and a data processing logic, wherein the verification assembly comprises a verification rule, wherein the behavior assembly comprises a task execution setting.

20. The data management method according to claim 19, wherein the data processing logic comprises an execution logic and a calculation model.
